(19) United States
(12) Patent Application Publication
(10) Pub. No.: US 2022/0381594 A1
(43) Pub. Date: Dec. 1, 2022

(54) VOLUME FLOW MEASUREMENT OF MATERIAL USING 3D LIDAR

(71) Applicant: ContiTech Transportbandsysteme GmbH, Hannover (DE)

(72) Inventors: Dustin Schiller, Sebexen (DE); Patrick Raffler, Goettingen (DE); Christian Hans Enders, Schwalbach (DE); Jack Bruce Wallace, Powell, OH (US)

(73) Assignee: ContiTech Transportbandsysteme GmbH, Hannover (DE)

(21) Appl. No.: 17/303,456

(22) Filed: May 28, 2021

(51) Int. Cl. G01F 1/66; G01N 21/85; G01N 21/88

(52) U.S. Cl. CPC G01F 1/661; G01N 21/85; G01N 21/8806

(57) ABSTRACT

A system for determining volume and flow characteristics for material on a conveyer belt is disclosed. The system includes an emitter, a sensor, and circuitry. The emitter is configured to generate radiation and direct the radiation toward a conveyer belt according to a field of view. The sensor is configured to measure reflected radiation from the conveyor belt and based on the generated radiation at a high framerate of about 20 to 30 Hertz and a high resolution of greater than about 4000 pixels and generate time of flight measurements. The circuitry is configured to generate time of flight measurements, determine three dimensional volume characteristics and flow characteristics for material conveyed by the conveyor belt using light detection and ranging based on the measured reflected radiation.

### FIELD

The field to which the disclosure generally relates is conveyor belts.

### BACKGROUND

Conveyor belts are often used to convey bulk materials. Typically, material is dropped or provided on a belt at one location and transported to a different location. However, measuring the amount of material moved is problematic.

One technique is to use mass scales that measure mass or weight at various points along a belt. These measurements of mass are then used to determine how much material is being transported. However, this technique is high in cost, requires regular calibration and has a low measurement accuracy.

What is needed are techniques to facilitate monitoring conveyor belt material with lower cost and higher accuracy.

### FIGURES

FIG. 1 is a diagram illustrating a conveyor belt material monitoring system 100 in accordance with one or more embodiments.

FIG. 2 is a diagram illustrating a conveyor belt material monitoring system 200 in accordance with one or more embodiments,

FIG. 3 is a diagram illustrating some example contours or profiles for use in accordance with one or more embodiments.

FIG. 4 is a diagram of a system 400 for determining volume and flow characteristics for a conveyor belt.

FIG. 5 is another diagram of the system 400 for determining volume and flow characteristics for a conveyor belt.

FIG. 6 is a flow diagram illustrating the method 400 of determining volume flow for a conveyor belt system in accordance with one or more embodiments.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Conveyor belts are often used to convey bulk materials. Typically, material is dropped or provided on a belt at one location and transported to a different location. However, measuring the amount of material moved is problematic.

One technique is to use mass scales that measure mass or weight at various points along a belt. These measurements of mass are then used to determine how much material is being transported. However, this technique is high in cost, requires regular calibration and has a low measurement accuracy.

Other techniques include laser sensors, radar sensors and the like. These approaches can also result in high cost and low accuracy.

One or more embodiments are disclosed that facilitate monitoring conveyor belt material using three dimensional (3D) Flash Lidar with lower cost and higher accuracy. Further, the embodiments can include material volume monitoring, belt alignment detection, slot protection monitoring, belt edge damage detection and the like.

Light detection and ranging (LIDAR) is a surveying technique that measures a distance to a target by illuminating a target with a laser light and measuring reflected light with one or more sensors. Variations in return times and wavelengths are used to make digital 3D representations of the target.

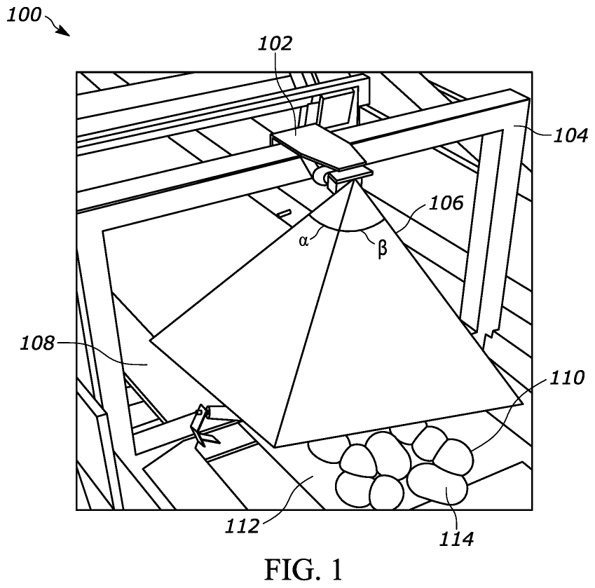

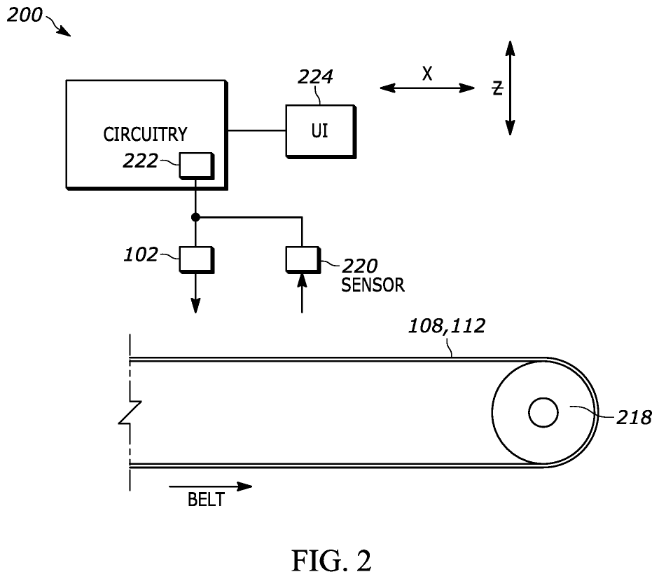

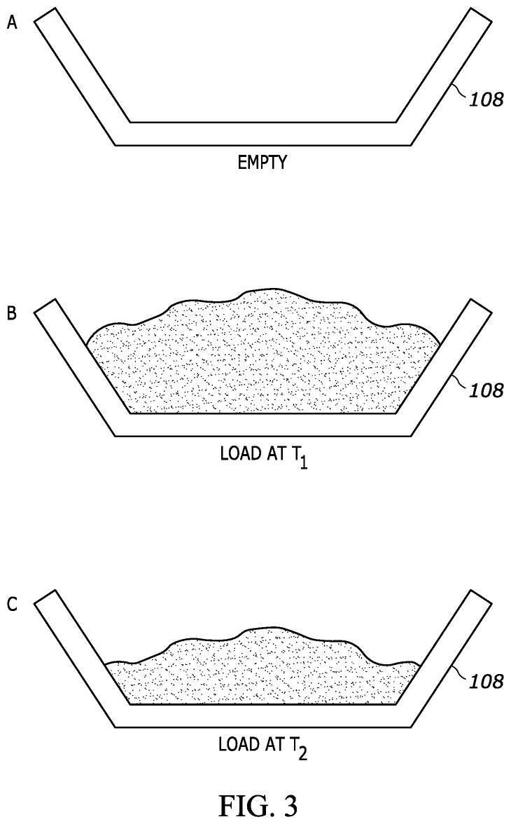

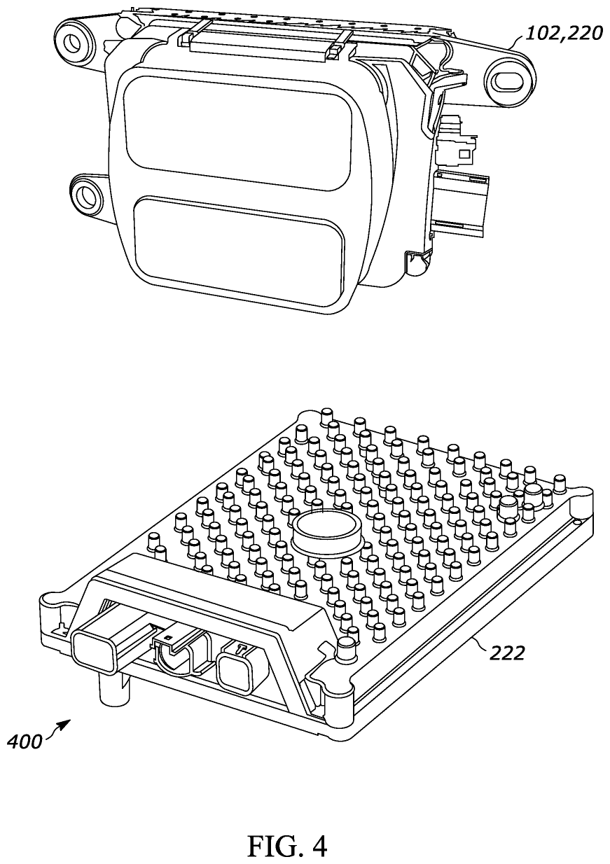

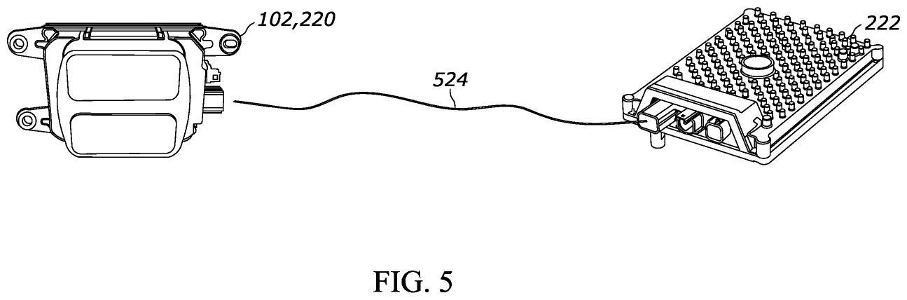

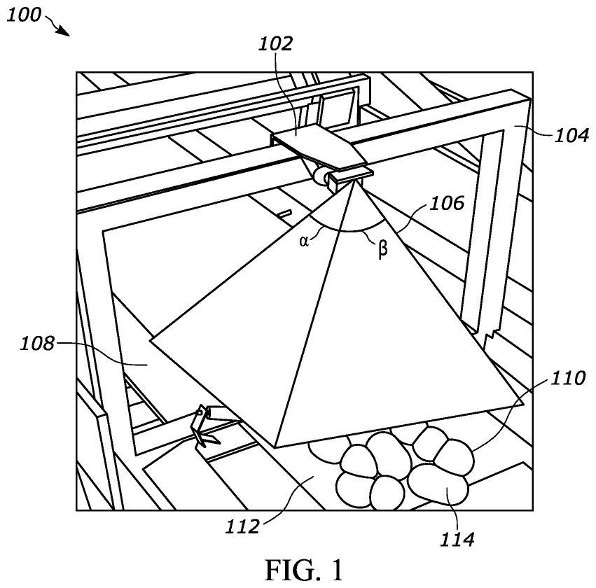

FIG. 1 is a diagram illustrating a conveyor belt material monitoring system 100 using LIDAR in accordance with one or more embodiments. The system 100 is provided for illustrative purposes and it is appreciated that suitable variations are contemplated.

The system 100 includes an emitter 102, a flash portal/support 104, rollers 108, a conveyor belt 112, material 110 114, and a belt support 116.

The system 100 uses LIDAR techniques to determine material volume monitoring, belt alignment detection, slot protection monitoring, belt edge damage detection and the like.

The emitter 102 operates as an energy source and generates radiation at a selected wavelength towards a target. The emitter 102 illuminates the material 110 being conveyed by the conveyor belt 112.

In one example, the emitter 102 is a laser generates radiation having about 600 to about 1000 nano-meters of wavelength. It is appreciated that other suitable wavelengths are contemplated.

In another example, the emitter 102 generates a collimated laser beam that illuminates a single point at a time and the beam is scanned point by point through a field of view.

In another example, the emitter 102 uses a form of flash LIDAR where a field of view is illuminated with a wide diverging laser beam in a single pulse.

In another example, the emitter 102 is a phased array and comprise an array of antennas to generate the radiation as a signal.

In one example, the emitter 102 illuminates the material 110 by scanning a laser across a horizontal direction of the page.

The emitter 102 has a field of view (FOV) specified in angle (α) and angle (β) directed toward the conveyor belt 112. The emitter 102 is positioned at a selected height based on the conveyor belt 112 and the field of view. The emitter 102 can also have a selected scanning rate that scans across the conveyor belt 112 sufficiently while the belt 112 is moving.

One or more sensors 220 (not shown in FIG. 1) measure reflected light from the material 110 and/or the belt 112. The one or more sensors 220 can be integrated into/with the emitter 102 or can be present in a separate element.

The sensors 220 can utilize photodetector technologies such as solid state photodetectors and the like. The sensors 220 typically scan along one or two axis.

In one example, the sensors 220 are active sensors that also operate as the emitter 102.

Circuitry 222 (not shown in FIG. 1) uses sensor measurements from the sensors to develop a 3D model, such as a 3D contour line or shape of the material. The circuitry is configured to build the 3D model using sensor measurements from a plurality of points in time.

The circuitry 222 then analyzes the built 3D model to determine belt transport properties that include volume of material, weight of material, volume of material transported per time (speed), type of material, distribution of material, belt alignment, edge detection, belt skew, start of material flow, end of material flow and the like.

The system 100, circuitry 222 monitors the material on the conveyor belt at the measuring point after the material is loaded onto the belt, preferably in near proximity to the load chute. From this position the sensor can monitor the profile of the material on the belt, in addition to the flow of the material on the conveyor which can include a calculation of the total amount of material on the conveyor belt to the discharge point. This can be accomplished by monitoring the belts movement and configuring the discharge point as a function of sensor position. The profile information can determine the loading level at the measurement location and determine if there is too much material on the belt, for example in accordance with the DIN/CEMA belt application standards, and there is a risk of spillage. (See, Conveyor Equipment Manufacturers Association (CEMA), “Belt Conveyors for Bulk Material”, 6th edition, second printing (2017), which is incorporated by reference. Alternatively, the total material loading on the conveyor belt can be determined by monitoring the total volume load on the conveyor to discharge. This can be used to determine the total belt loading and calculate the belt tension. Also in accordance to DIN/CEMA standards, the calculated tension can be utilized to determine if the belt is being put in an overload condition, and the system can generate an alert/alarm for this condition.

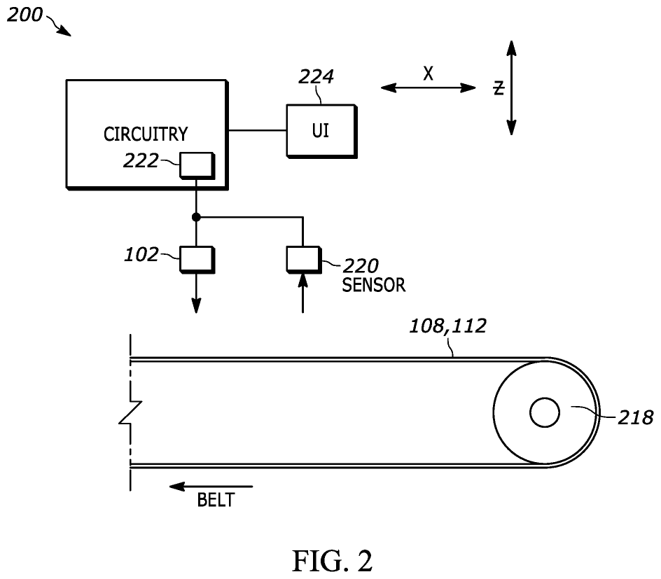

FIG. 2 is a diagram illustrating a conveyor belt material monitoring system 200 in accordance with one or more embodiments. The system 200 is provided for illustrative purposes and it is appreciated that suitable variations are contemplated.

The system 200 is similar to the system 100 and includes an emitter 102, one or more sensors 220, belt rollers 218, a conveyor belt 112, circuitry 222 and a user interface 224.

The system 200 uses LIDAR to determine material volume monitoring, belt alignment detection, slot protection monitoring, belt edge damage detection and the like.

The emitter 102 illuminates a selected portion of the conveyor belt 112. In one example, the emitter 102 illuminates the material 110 by scanning a laser across a surface of the belt 112.

As described above, the emitter 102 has a field of view (FOV), specified in angle (α), and directed toward the conveyor belt 112. The emitter 102 is positioned at a selected height based on the conveyor belt 112 and the field of view. The LIDAR 102 can also have a selected scanning rate that scans across the conveyor belt 112 sufficiently while the belt 112 is moving.

One or more sensors 220 measure reflected light from the material and/or the belt 112. The one or more sensors 220 can be integrated into the LIDAR 102 or can be present in a separate element.

Circuitry 222 uses sensor measurements from the sensors to develop a 3D model, such as a 3D contour line or shape of the material. The circuitry is configured to build the 3D model using sensor measurements from a plurality of points in time.

The circuitry 222 then analyzes the built 3D model to determine belt transport properties/characteristics that include volume of material, weight of material, volume of material transported per time (speed), type of material, distribution of material, belt alignment, edge detection, belt skew, start of material flow, end of material flow and the like.

In one example, the circuitry 222 generates a base or initial model of the belt 112 when material is not being conveyed. The base model can then be used as a reference with other generated models to determine material volume and other belt characteristics.

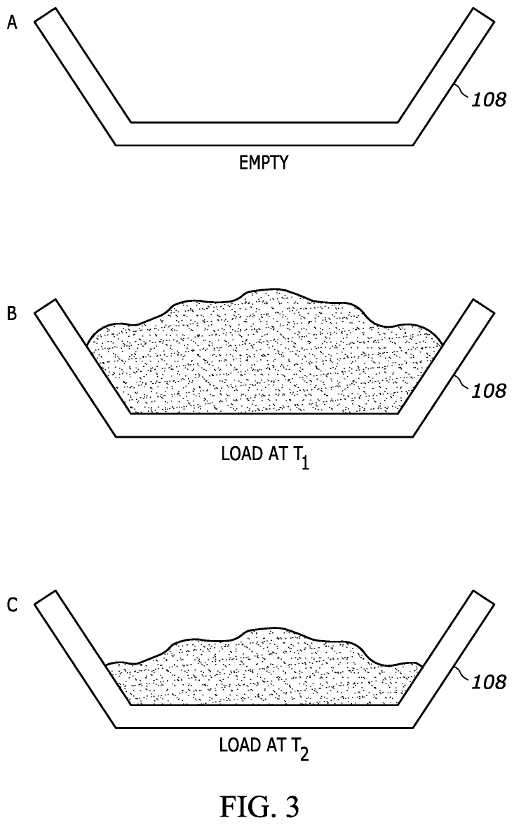

FIG. 3 is a diagram illustrating some example contours or profiles for use in accordance with one or more embodiments. The examples are provided for illustrative purposes and it is appreciated that suitable variations are contemplated.

The profile A depicts the conveyor belt 112 empty or without material at an initial time (t0).

The profile B depicts the conveyor belt 112 with a material load at a first time (t1) after the t0.

The profile C depicts the conveyor belt 112 with a second material load at a second time (t2) after the t1.

The circuitry 222 can use sensor measurements for the t0 to generate a base model.

The circuitry 222 can use sensor measurements for the t1 to generate a material load model at the t1.

The circuitry 222 can use sensor measurements at t2 to generate a second load model.

The circuitry 222 is configured to use the base model, first load model, second load mode and the times t0, t1, and t2 to generate belt transport properties/characteristics as described above.

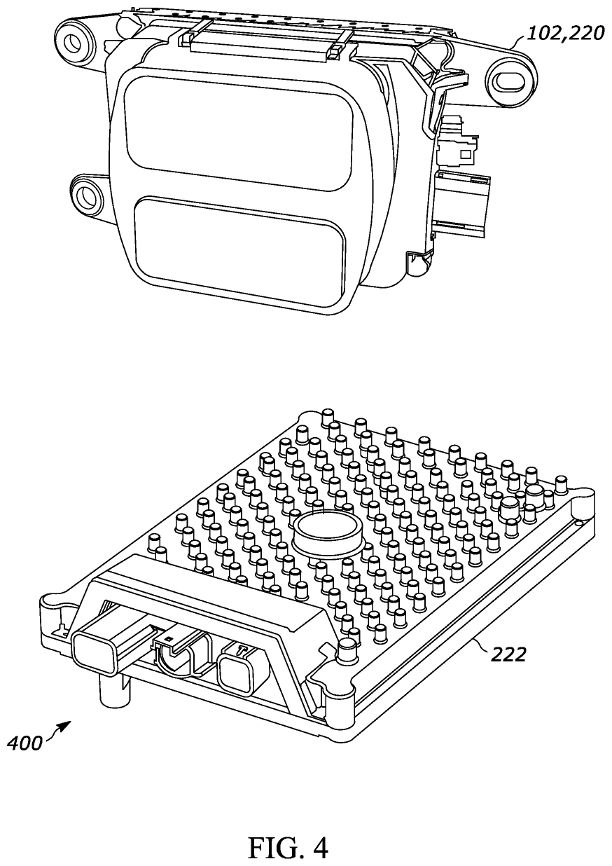

FIG. 4 is a diagram of a system 400 for determining volume and flow characteristics for a conveyor belt. The system 400 is provided for illustrative purposes and it is appreciated that suitable variations are contemplated,

The system 400 is an example embodiment of the systems 100, 200 and variations thereof.

In this example, the emitter 102 and sensor 220 are combined in a single package or component, referred to as a sensor head.

The circuitry 222 is incorporated into a processing data converter unit (DCU).

The sensor head 102, 220 and the processing DCU 222 each include one or more ports/connections for transferring power and/or information,

In one example, the sensor head 102, 220 can be mounted on top of the processing DCU 222.

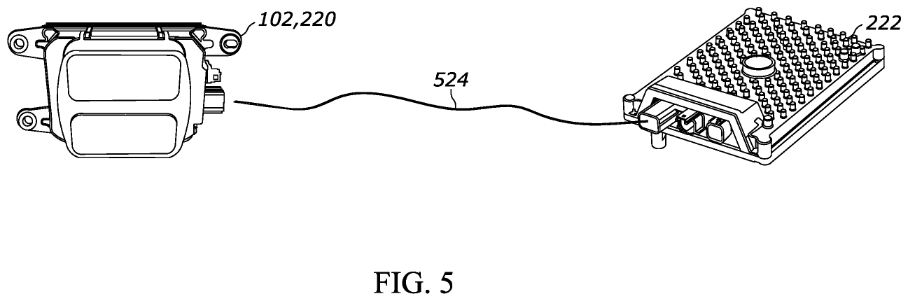

FIG. 5 is another diagram of the system 400 for determining volume and flow characteristics for a conveyor belt.

Here, the sensor head 102,220 is remote from the processing DCU 222. They are connected via a wired connection or cable 524 in this example. The connection 524 is a low voltage data connection that transfers information between the sensor head 102, 220 and the DCU 222.

In one example, the sensor head 102, 220 has a field of view (FOV) of (120° x30° ), a power consumption of about 9 watts and a weight under 700 grams.

In one example, the DCU 222 includes a Gigabit Ethernet port, uses a Precision Timing Protocol, a power consumption of less than about 9 watts, a weight of under 700 grams, and generates streaming point cloud data and an intensity map based on information and/or measurements from the sensor head 102, 220.

The circuitry/DCU 222 can utilize the intensity map and/or cloud data to determine volume and flow characteristics for material transferred on a conveyor belt.

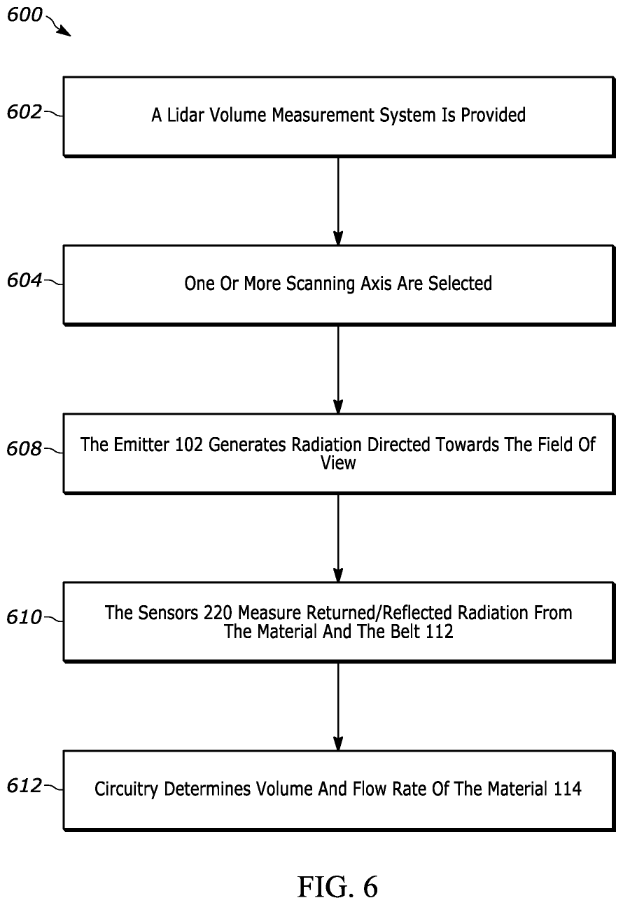

FIG. 6 is a flow diagram illustrating a method 600 of determining volume flow for a conveyor belt system in accordance with one or more embodiments. The method 400 is provided for illustrative purposes and it is appreciated that suitable variations are contemplated.

The method 600 can be performed using the system 100, 200 and suitable variations thereof.

The method 600 begins at 602, where a LIDAR volume measurement system is provided. The system can be the system 100, 200 and/or variations thereof. The system includes the emitter 102, the sensor 220, the belt 112 and operates on the material 114.

One or more scanning axis are selected at 604.

A field of view is selected at 606.

The emitter 102 generates radiation directed towards the field of view at 608.

The sensors 220 measure returned/reflected radiation from the material and the belt 112 at 610.

Circuitry determines volume and flow rate of the material 114 at 612.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A system for determining volume and flow characteristics for a conveyer belt, the system comprising:
an emitter configured to generate radiation and direct the radiation toward a conveyer belt according to a field of view in first direction (α) and a second direction (β);
a sensor configured to measure reflected radiation from the conveyor belt and based on the generated radiation at a high framerate of about 20 to 30 Hertz and a high resolution of greater than about 4000 pixels and generate time of flight measurements; and
circuitry configured to generate time of flight measurements, determine three dimensional volume characteristics and flow characteristics for material conveyed by the conveyor belt using light detection and ranging based on the measured reflected radiation.

2. The system of claim 1, the circuitry additionally configured to determine ore size, belt alignment, belt edge damage, belt speed, longitudinal rip detection and belt surface damage based on the measured reflected radiation based on detected lateral motion of the material over a known distance and time as established by the time flight measurement.

3. The system of claim 2, the circuitry additionally configured to compare the measured reflected radiation with a threshold for foreign object dimensions to determine presence of foreign objects on the conveyor belt based on the measured reflected radiation.

4. The system of claim 1, the circuitry additionally configured to generate a belt map for the conveyor belt, compare the generated belt map with the measured reflected radiation and detect damages along belt edges of the conveyor belt and surface defects along a surface of the conveyor belt based on the comparison.

5. The system of claim 4, the circuitry identifies a width increase of the belt based on the comparison.

6. The system of claim 1, wherein the field of view is 120 degrees in a lateral direction and 30 degrees in a conveyance direction and has a resolution of about 64 to 128 pixels in the lateral direction and of about 8 to 32 pixels in the conveyance direction.

7. The system of claim 1, the circuitry configured to detect visual interference and mitigate or remove the visual interference from the volume characteristics and flow characteristics, the visual interference comprising one or more of rain, dust, smoke, sun and fog.

8. The system of claim 1, where the circuitry is configured to capture a liner cross section as a function of belt displacement or time to calculate a volume flow that passes through the field of view based on a time of flight measurement.

9. The system of claim 1, wherein the circuitry is configured to detect a longitudinal rip based on detection of a longitudinal slit in the conveyor belt surface.

10. The system of claim 1, the circuitry configured to detect a change width of the belt and/or a change in the material volumetric profile based on the measured reflected radiation.

11. The system of claim 1, the emitter configured to generate the radiation using a full frame single pulse laser.

12. The system of claim 1, the emitter comprising a class 1 eye-safe 1064 nanometer laser and operable on 12 volt DC.

13. The system of claim 1, the emitter and the sensor configured to operate in a temperature range of about −30 degrees C. to about 105 degrees C.

14. The system of claim 1, further comprising an integrated heater.

15. The system of claim 1, further comprising a washing system.

16. The system of claim 1, the circuitry configured to determine overloading of the belt based on the measured reflected radiation.
